(19) United States
(12) Patent Application Publication
(10) Pub. No.: US 2004/0173926 A1
(43) Pub. Date: Sep. 9, 2004

(54) Method for making man-made stone slab for decoration

(76) Inventor: Kecheng Fang, Taipei (TW)

Correspondence Address: DELLETT AND WALTERS, P. O. BOX 2786, PORTLAND, OR, 97208-2786, US

(21) Appl. No.: 10/482,448

(22) PCT Filed: Jul. 27, 2001
(86) PCT No.: PCT/CN01/01210

(51) Int. Cl. B29C 41/22

(52) U.S. Cl. 264/77

(57) ABSTRACT

This invention discloses a method for manufacturing synthetic stone board for building or decorative purposes. The method has acts of putting sand particles into multiple material containers, adding thick liquid basic materials with different colors and concentrations respectively into the material containers and mixing the sand particles and the thick liquid basic materials by means of completely stirring to achieve mixtures in the material containers. The mixtures are taken from the material containers and added to a mixing container in a desired proportion in colors of the manufactured synthetic stone board, and are then stirred in the mixing container to achieve a mixed mixture. The mixed mixture is compressed from the mixing container into a mold and is pressed in the mold with pressure to achieve a semi-finished product. With a solidifying process, a synthetic stone board with natural grains and desired colors is provided.

The is application is an application of the National Stage of International Application No. PCT/CN01/01210, filed on Jul. 27, 2001.

### BACKGROUND OF THE INVENTION

1. Field of the Invention

The present invention relates to a method for manufacturing synthetic stone board for building or decorative purposes, and more particularly to a method for manufacturing synthetic stone board with a light weight and an aesthetic appearance similar to that of natural stone.

2. Description of Related Art

Stone has been a very popular material for building throughout the history of civilization. Even after cement was devised, stone has occupied a very important place in the design and construction of all types of building. Compared to the generally unaesthetic cement, stone with a natural aesthetic appearance is a very popular choice of building material. Therefore, stone can be found used as outer walls, columns, steps or floors for decoration of a modem reinforced cement building. However, because locating sources, mining or quarrying, dressing, transporting, and mounting of stone are all difficult and troublesome, the cost for using stone is high. Thus, stone cannot be used as widely as it might be buildings, so tiles or the like instead of stone are used. Thus, many people are denied their first choice of building material because stone is beyond their economic reach. To solve the aforementioned problems of natural stone, synthetic stone has been developed with a low cost, low weight and convenient manufacture. For instance, a Taiwan invention patent application to a Japanese inventor and entitled “Synthetic Stone And Method For The Same”, with application number 83110765, is related to a method for manufacturing synthetic stone. The '765 application comprises a method of manufacturing a synthetic stone by means of mixing an inorganic mixture with a resin or resin mixture, wherein the inorganic mixture is a mixture of inorganic fine particles with diameter from 10 to 70 mesh and inorganic very fine particles with diameter less than 100 mesh. Wherein, the weight of the inorganic fine particles is more than 10% of the weight of the entire synthetic stone. The inorganic fine particles are coated with stiffened inorganic or organic material, wherein the stiffened inorganic or organic material is chosen from one of the group comprising sodium silicate (water glass), sodium silicate with pigment and frit for pottery.

The aforesaid synthetic stone can solve the problems of accessing material, cutting, transporting and assembling of stone, but the surface of the synthetic stone has only a single color. The conventional synthetic stone does not have any change in color or grain and resembles natural sandstone, thus the conventional synthetic stone cannot provide versatile colors and charming grains of nature.

In another Taiwan patent application, entitled “Synthetic Slate Or Clay Carving Material” with application serious number 88117730 provides another method for manufacturing synthetic stone. The method comprises acts of mixing calcined natural stone powders or clay powders with waterproof agents, fibers or resin to form an upper thick liquid, mixing pebbles with resin to form a lower thick liquid, putting the lower thick liquid into a mold and putting the upper thick liquid into the mold to cover the lower thick liquid, whereafter the thick liquid is pressurized to achieve a semi-finished product with grains of slate or statues on the top surface. After drying at a low temperature, a synthetic slate with grains of slate or three-dimensional statues on the top surface and a rough bottom surface is achieved.

The '730 application is superior to the '765 application because the synthetic slate of the '730 application can show the natural rock grains or three-dimensional statues by the differences in sizes of the pebbles and the stone powders to provide a good tactile result as well as a visible effect similar to that of a natural stone.

However, from an expert viewpoint, the aforementioned applications can only provide a single colored synthetic product or a synthetic product with stone materials having different colors and evenly arranged on the surface of the product. That means the methods of the aforementioned applications can be used to manufacture a synthetic stone similar to sandstone or granite, but cannot be used to manufacture a synthetic stone with different colors combined with natural grains like marble. Therefore, a synthetic stone with different colors combined with natural grains is still not provided to the architectural or building decoration industries.

### SUMMARY OF THE INVENTION

The main objective of the invention is to provide a method for manufacturing synthetic stone board for building or decorative purposes, the method can produce synthetic stone with different and natural colors.

The objective of the invention is achieved by providing a method for manufacturing synthetic stone board for building or decorative purposes and comprises acts of putting sand particles into multiple material containers, adding thick liquid basic materials with different colors and concentrations respectively into the material containers and mixing the sand particles and the thick liquid basic materials by means of stirring to achieve mixtures with different colors and concentrations respectively in the material containers. The mixtures with different colors are taken from the material containers and put into a mixing container in a desired proportion in colors of the manufactured synthetic stone board, and are then stirred in the mixing container to achieve a mixture. The mixture is compressed from the mixing container into a mold and is pressurized in the mold, and a semi-finished product with a basic shape is achieved. After taking the semi-finished product from the mold, the semi-finished product will solidify to achieve a synthetic stone board with natural grains and desired colors.

The objective of the invention can be also achieved by providing a method for manufacturing synthetic stone board for building or decorative purposes and comprises acts of putting pottery clays and thick liquids with different colors and concentrations respectively into multiple material containers and stirring the pottery clays and thick liquids in the material containers to achieve mixtures with different colors and concentrations respectively in the material containers. The mixtures with different colors are taken from the material containers in lumps and are taken into a mixing container in desired proportion of colors of the manufactured synthetic stone, and are then stirred in the mixing container to achieve a mixture. The mixture is compressed from the mixing container into a mold and is pressurized in the mold, and a semi-finished product with a basic shape is achieved. The semi-finished product is processed with the steps of being soaked in water, drying and compression in sequence, and is then processed with the solidifying steps of stoving and sintering to achieve a synthetic stone board with natural grains and desired colors.

The synthetic stone board manufactured by aforementioned method has the advantages of having a light weight and an aesthetic appearance in colors and resembling natural stone.

### BRIEF DESCRIPTION OF THE DRAWINGS

FIG. 1 is a flow chart of a method in accordance with the present invention with using resin or cement as basic material;

FIG. 2 is a flow chart of a method in accordance with the present invention with using pottery clay and thick liquid as basic material;

FIG. 3 is a side plan view of a synthetic stone board made by a method in accordance with the present invention;

FIG. 4 is a side plan view of a first embodiment of a product made by a method in accordance with the present invention; and

FIG. 5 is a side plan view of a second embodiment of a product made by a method in accordance with the present invention.

### DETAILED DESCRIPTION OF PREFERRED EMBODIMENT

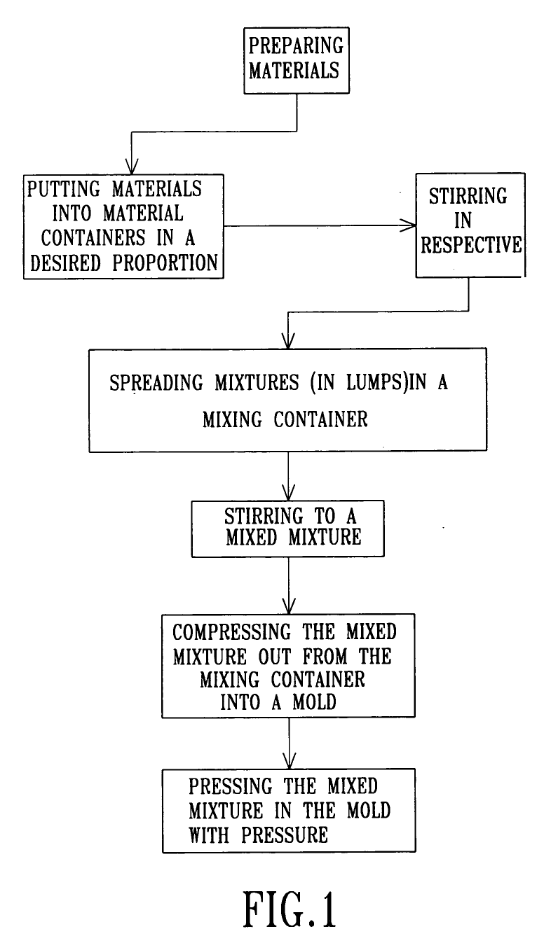

FIG. 1 is a flow chart of a method in accordance with the present invention with using resin or cement as basic material. Firstly, preparing materials involves processing of the materials which include sand particles and thick liquid basic materials. Wherein, the sand particles can be quartz sands, ore sands, glass sands and so on, and the thick liquid basic materials can be resin, such as epoxy resin or poly resin or cement. The thick liquid basic materials can be appropriately dyed or different basic materials with different colors and concentration can be used. Wherein, the skill for dyeing the resin is well known in the art and is not further described. In addition, when resin is used as the basic material, a stiffening agent is selectively used according to the resin used. To dye the cement is also well known. For example, white cement can be used as a base and pigments with different colors are selectively added into the base to make the cement show different colors, such as red, yellow, blue, green and so on. Without adding any pigment, white is naturally presented.

After the process of preparing the materials, sand particles are put respectively into multiple material containers. In the meantime, thick liquid basic materials with different colors and concentrations are respectively put into the material containers. If resin is used as the basic material, stiffening agents are simultaneously added into the material containers. Then, the sand particles and the thick liquid basic materials are mixed by means of stirring to achieve mixtures with different colors and concentrations respectively in the material containers. The mixtures with different colors are taken from the material containers and put into a mixing container in a predetermined proportion, and the mixtures are then stirred in the mixing container to achieve a subsequent mixture. This subsequent mixture is compressed from the mixing container into a mold and is pressurized in the mold, and a semi-finished product with a basic shape is achieved. After taking the semi-finished product from the mold, the semi-finished product will solidify to achieve a synthetic stone board made by the method in accordance with the present invention.

In the above mentioned processes, because the thick liquid basic material put into the material containers may have different colors, the mixtures in the material containers also have different colors. The mixtures can be put into the mixing container in lumps and based on a desired proportion. For example, if the proportion in colors on the surface of the desired synthetic stone board is 60% white, 30% green and 10% dark green, the mixture in material container A is white, the mixture in material container B is green, and the mixture in material container C is dark green. Sand particles and basic materials are put into the material containers in different weight proportions based on the above color proportion and are stirred after the process of preparing materials in accordance with the present invention. Adding the mixtures to the mixing container is also in a proportion according to the above color proportion, and can be processed by one of the following:

(1). The number of lumps of mixture in each material container put into the mixing container is same as that in another material container. Each lump of mixture in material container A has a weight of 6 units, each lump of mixture in material container B has a weight of 3 units, and each lump of mixture in material container C has a weight of 1 unit; or

(2). Each lump of mixture in all material containers has a same weight. Six lumps of mixture in the material container A are added to the mixing container in one unit of time, three lumps of mixture in the material container B are added to the mixing container in one unit of time, and one lump of mixture in the material container C is added to the mixing container in one unit of time.

The two ways of different adding mixtures into the mixing container will make two different synthetic stone boards with different grains. The user can choose the different ways based on the needs and can process the different ways alternatively. Accordingly, differently-mixed mixtures with a same proportion but different grains are achieved.

The mixtures in the material containers are added to the mixing container and are lightly stirred. The purpose of stirring is to appropriately mix the thick liquid or mud type mixtures with different colors and concentrations to make the mixed mixture variegated, but is not to combine the mixtures to make the mixed mixture have a single color. Consequently, the mixtures with different colors and concentrations from different material containers will be mixed during being stirred in and being compressed from the mixed container. The boundary line between the mixtures with different colors will be distorted but be still maintained to separate the colors. The semi-finished product of the synthetic stone board in the mold will have natural colors and grains resembling natural stone.

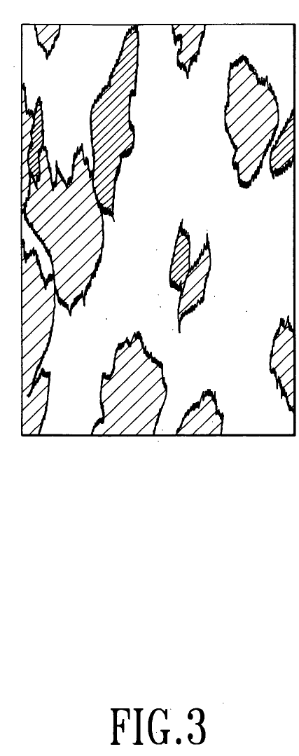

Then, different stiffening processes are applied to different semi-finished products in the mold according to the basic material for the synthetic stone. If the basic material is resin, the semi-finished product will be solidified with the stiffening agent. If the basic material is cement, the semi-finished product will solidify by itself or be air-dried. Accordingly, a synthetic stone board with natural grains and desired colors as shown in FIG. 3 is achieved.

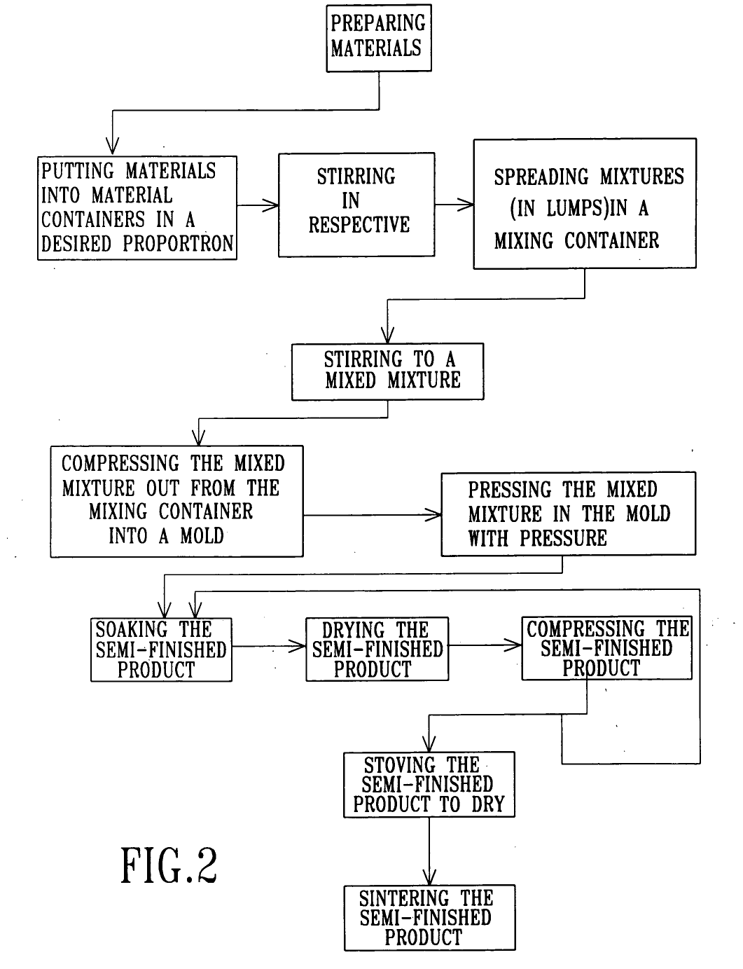

FIG. 2 shows a flow chart of a method in accordance with the present invention using pottery clay and thick liquid as basic materials. When using the pottery clay and thick liquid as basic materials, the sand particles are unnecessary in the preparing material process and pottery clays and thick liquids with different colors and concentrations are used instead. To provide special effect or to adjust the density of the pottery clay, sand particles can be added to the pottery clays and thick liquids that have different colors and concentrations and are put respectively into multiple material containers. After stirring completely, a mixture with a specific color and concentration is provided in each respective material container. The mixtures with different colors are taken from the material containers in lumps and added to a mixing container in a predetermined proportion, and the mixtures are then stirred in the mixing container to achieve a subsequent mixture. That mixture is then compressed from the mixing container into a mold and is pressurize in the mold, and a semi-finished product with a basic shape is achieved. The process for manufacturing the semi-finished product is same as that of the method in FIG. 1 and is not further described.

Because the densities of the pottery clays with different colors and concentration are different, cracks will occur on the boundary lines of the mixtures with different colors if the semi-finished product is directly sent to a kiln for sintering after being taken out from the mold. The manufacturing quality of the method is lowered. Therefore, an equivalent process must be applied to the semi-finished product to equalize the density of the semi-finished product. The equivalent process comprises steps of soaking the semi-finished product in water, drying the semi-finished product and compressing the semi-finished product. If the densities of the basic materials have large differences, the equivalent process can be repeatedly applied to make the densities of the basic materials substantially equal to each other. A solidifying step of stoving and sintering is applied to the semi-finished product to achieve a synthetic stone board with natural grains and desired colors and with using pottery clays and thick liquids as basic materials.

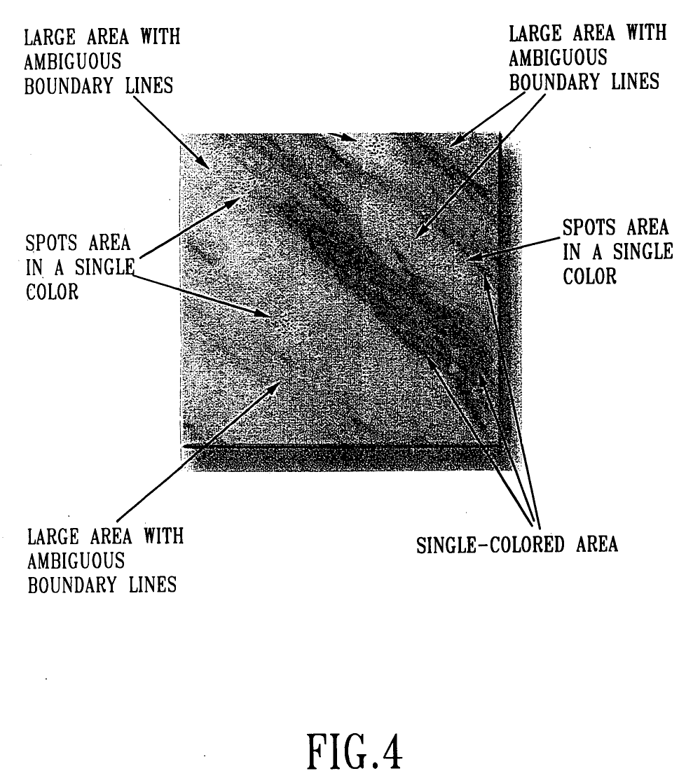

FIG. 4 shows a synthetic stone board made by the method in accordance with the present invention. The synthetic stone board has large areas in white and gray, single-colored areas in dark grays and block spots areas. The boundary lines between white and gray areas are diffused because the mixtures in white and gray in the material containers have thick liquids with a proportion much greater than that of sand particles. The boundary lines of the mixtures in white and gray between the other colored mixtures are presented with natural grains with a diffused boundary. The single-colored area is presented with a united area. To achieve the united single-colored area, the mixture in the material container has half thick liquid and half sand particles, and the mixture is sent to the mixing container in lumps. Consequently, when the mixture is compressed in the mold, a united area with single color will be achieved. In addition, the spotted areas are achieved by providing a mixture with high proportion in sand particles and low proportion in thick liquid. When the mixture is sent into the mixing container, particles will be spread in the mixing container and spots in a single color will occur on the surface of the synthetic stone board. Wherein, the proportions between the areas are determined by the proportions of the mixtures in the material containers added to the mixing container. Therefore, synthetic stone boards with a same proportion in colors can be provided.

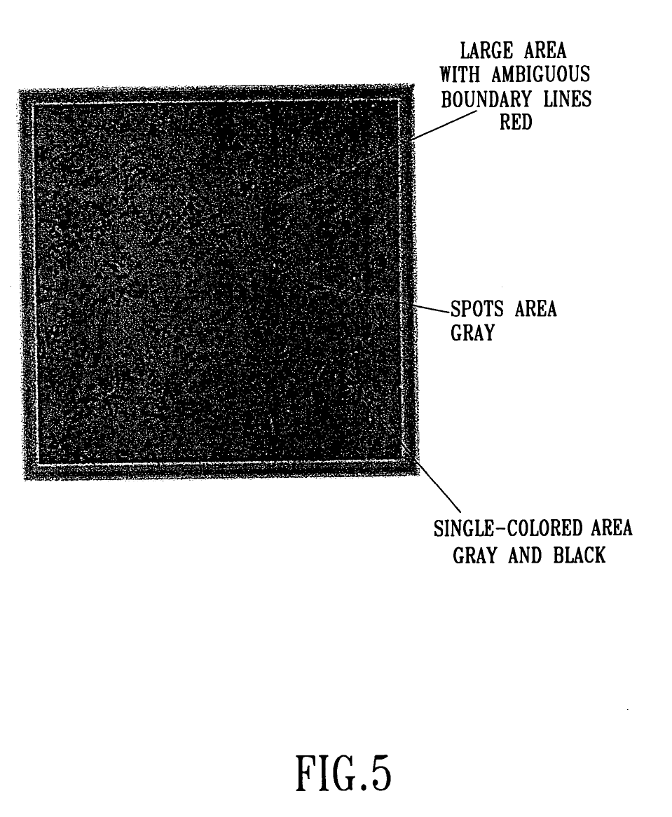

With reference to FIG. 5, another synthetic stone board made by the method in accordance with the present invention is shown.

What is claimed is:

1. A method for manufacturing synthetic stone board for building or decorative purposes comprising acts of putting sand particles into multiple material containers, adding thick liquid basic materials with different colors and concentrations respective into the material containers, mixing the sand particles and the thick liquid basic materials by means of stirring to achieve mixtures with different colors and concentrations respectively in the material containers, taking the mixtures with different colors out from the material containers and addin the mixtures to a mixing container in a desired proportion in colors of the manufactured synthetic stone board, slightly stirring the mixtures in the mixing container to achieve a mixed mixture, compressing the mixed mixture out from the mixing container into a mold, pressurizing the mixed mixture in the mold to achieve a semi-finished product with a basic shape, taking the semi-finished product from the mold, and solidifying the semi-finished product to achieve a synthetic stone board with natural grains and desired colors.

2. The method for manufacturing synthetic stone board for building or decorative purposes as claimed in claim 1, wherein the proportions of the sand particles and thick liquid basic materials with different colors and concentrations in different material containers are determined by the desired proportion in colors of the manufactured synthetic stone board.

3. The method for manufacturing synthetic stone board for building or decorative purposes as claimed in claim 1, wherein the mixtures with different colors in the material containers are sent into the mixing container in lumps base on the desired proportion in colors of the manufactured synthetic stone board and the mixtures with different colors are stirred in the mixing container to achieve the mixed mixture.

4. The method for manufacturing synthetic stone board for building or decorative purposes as claimed in claim 1, wherein the manner of sending the mixtures into the mixing container is sending the same number of lumps of mixtures in the material containers into the mixing container, and weight proportions of the lumps in different material containers are the same as the desired proportion in colors of the manufactured synthetic stone board.

5. The method for manufacturing synthetic stone board for building or decorative purposes as claimed in claim 1, wherein the manner of sending the mixtures into the mixing container is sending lumps of mixtures in the material containers into the mixing container, each lump has a same weight and numbers of the lumps in different material containers are based on the desired proportion in colors of the manufactured synthetic stone board.

6. The method for manufacturing synthetic stone board for building or decorative purposes as claimed in claim 1, wherein the sand particles are quartz sands, ore sands or glass sands.

7. The method for manufacturing synthetic stone board for building or decorative purposes as claimed in claim 1, wherein the sand particles are mixtures of quartz sands, ore sands and glass sands.

8. The method for manufacturing synthetic stone board for building or decorative as claimed in claim 1, wherein the thick liquid basic materials are resin, and a stiffening agent is put into a corresponding one of the material containers when the thick liquid basic materials is put into the material container.

9. The method for manufacturing synthetic stone board for building or decorative purposes as claimed in claim 8, wherein the thick liquid basic materials are epoxy resin.

10. The method for manufacturing synthetic stone board for building or decorative purposes as claimed in claim 8, wherein the thick liquid basic materials are poly resin.

11. The method for manufacturing synthetic stone board for building or decorative purposes as claimed in claim 8, wherein the thick liquid basic materials are cement.

12. A method for manufacturing synthetic stone board for building or decorative comprising acts of putting pottery clays and thick liquids with different colors and concentrations respectively into multiple material containers, stirring the pottery clays and thick liquids in the material containers to achieve mixtures with different colors and concentrations respectively in the material containers, sending the mixtures with different colors and concentrations out from the material containers in lumps and into a mixing container in a desired proportion in colors of the manufactured synthetic stone, stirring the mixtures in the mixing container to achieve a mixed mixture, compressing the mixed mixture out from the mixing container and into a mold, pressurizing the mixed mixture in the mold to achieve a semi-finished product with a basic shape, applying an equivalent process to the semi-finished product to equalize the density of the semi-finished product, wherein the equivalent process comprises acts of soaking the semi-finished product in water, drying the semi-finished product and compressing the semi-finished product, and applying a solidifying process of stoving and sintering to the semi-finished product to achieve a synthetic stone board with natural grains and desired colors.

13. The method for manufacturing synthetic stone board for building or decorative as claimed in claim 12, wherein the proportions of the pottery clays and thick liquids in different material containers are determined by the desired proportion in colors of the manufactured synthetic stone board.

14. The method for manufacturing synthetic stone board for building or decorative as claimed in claim 12, wherein the manner of sending the mixtures into the mixing container is sending the same number of lumps of mixtures in the material containers into the mixing container, and weight proportions of the lumps in different material containers are same as the desired proportion in colors of the manufactured synthetic stone board.

15. The method for manufacturing synthetic stone board for building or decorative purposes as claimed in claim 12, wherein the manner of sending the mixtures into the mixing container is sending lumps of mixtures in the material containers into the mixing container, each lump has a same weight and number of the lumps in different material containers are based on the desired proportion in colors of the manufactured synthetic stone board.

16. The method for manufacturing synthetic stone board for building or decorative as claimed in claim 12, wherein the equivalent process of soaking the semi-finished product in water, drying the semi-finished product and compressing the semi-finished product is repeatedly applied to the semi-finished product.
